(19) United States
(12) Patent Application Publication
(10) Pub. No.: US 2006/0200414 A1
(43) Pub. Date: Sep. 7, 2006

(54) Methods of copy protecting software stored on portable memory

(76) Inventor: Henry A. Roberts JR., Leavenworth, IN (US)

Correspondence Address: Brian L. Michaelis;Brown Rudnick Berlack Israels, LLP, One Financial Center, Boston, MA, 02111, US

(21) Appl. No.: 11/352,656

(22) Filed: Feb. 13, 2006

Related U.S. Application Data
(60) Provisional application No. 60/652,563, filed on Feb. 14, 2005.

(51) Int. Cl. G06Q 99/00

(52) U.S. Cl. 705/50

(57) ABSTRACT

Memory copy protection by structuring the sector arrangement of memory devices in such a way as to allow access to the data stored in the sectors of the device without compromising the protection of the data is disclosed. Methods of protecting data stored in nonvolatile RAM memory from access and copying are disclosed, and methods that will enable software to distinguish between originals data and illegal or unauthorized copies of the nonvolatile memory. A method and device for securely authorizing the use of a computer program is also provided.

### CROSS REFERENCE TO RELATED APPLICATIONS

This application claims the benefit under 35 U.S.C. §119(e) of co-pending and commonly-assigned U.S. Provisional application Ser. No. 60/652,563 entitled “MEMORY COPY PROTECTION” filed on Feb. 14, 2005, by Henry A. Roberts, which application is incorporated by reference herein.

### FIELD OF INVENTION

The present invention relates to copy protection, more particularly, to a system and method of copy protection for computer memory devices.

### BACKGROUND OF INVENTION

Many software manufacturers in the market today require a purchaser and end-user to obtain a license to use the manufacturer's software. Some programs contain a dialog box that appears during installation of the program with the license information. When an end-user signals they accept the terms and conditions of the license, usually by clicking an “ACCEPT” button, the program is then installed on the computer and the program is authenticated.

In advanced software environments however, it becomes difficult to monitor and control the licenses given out by a manufacturer to multiple end-users. Several software licenses are sold with usage restrictions that limit the number of users, or provide expiration dates. The multitude of types of usage restrictions coupled with the number of end-users who had purchased the program creates a difficult situation to maintain control over the usage of protected software programs.

In order to maintain control of the number of software applications sold and in use, the manufacturer must still use a license scheme to ensure the software is not being used or distributed illegally. It is common for software manufacturers to utilize a method of authentication in which the program, upon running, will search the hard drive of the computer to locate a license file. This file contains information that will authorize the computer to run the licensed program. A typical license file is stored on the hard drive and contains an encrypted key or number. The program then searches the hard drive for the license file and verifies the authenticity of the encrypted key contained therein. If the program code does not find the encrypted key or the key is not authenticated, the program initialization fails; if the key is present and authenticated, the program operation proceeds.

Software manufacturers, in order to maintain control over their software usually use a unique identifier of the computer on which the software runs to identify an authorized computer. For example, a license may contain an encrypted version of the media access control (“MAC”) address of the Ethernet card. The MAC address is a serial number that is unique to that piece of hardware. Upon initiation of the program, the code of the program searches the drive for the license file. The license file, provided separately by the manufacturer, contains an encrypted form of the MAC address. If this number in the license file, when decrypted, does not match the MAC address of the Ethernet card, the authentication fails. If the key matches the MAC address, the program continues to load. Other license schemes can employ unique identifiers for several other hardware devices in the system. For example, a scheme may use the type graphics card or the BIOS ROM which contains its own unique identifier.

Problems arise with this sort of scheme if the piece of hardware, to which the license is tied, requires replacement. Hardware like motherboards and graphics cards are replaced with great frequency and require the user to obtain a new license from the manufacturer that is tied to a new identifier on the replacement piece of hardware. Not only can this be a tedious and time consuming process, but it subjects the manufacturer to fraudulent requests for additional licenses. A user, in an attempt to defraud the manufacturer, can simply notify the manufacturer of the need for a new license due to a hardware failure. If the new license is provided and there is no hardware failure, the manufacturer has just given out a free license to its software. The manufacturer must decide either to provide the license or alienate the end-user by refusing the request for a new license, believing the request to be fraudulent.

Other methods for authenticating a license include using an absolute location identifier for the license files. The program code looks to a specified fixed location on the hard drive to find the license file. If the license information is not in that specified location the program will not authenticate. Attempts to fraudulently copy all of the files to another computer will result in the license file being out of place, and prevent the product from being authenticated.

The difficulty of requiring an absolute location for a license file is that regular maintenance and equipment crashes can spoil the license scheme. Certain defragmenting tools can increase drive efficiency on larger memory devices by repositioning files on the drive, including the license file. The license file may reside on a data block that is repositioned during the defragmenting process. Upon initialization of the program, the license authenticating process can not find the license information in the correct location and the program authentication will fail. Additionally, if the drive crashes, the authorization to use the product is destroyed and the drive content is generally unavailable. Variations of different authentication schemes determine how catastrophic a crash must be to spoil the authentication process, however reformatting the drive, in all cases, will likely destroy the license file.

Other schemes used by leading companies in the field tie the authentication of the software to the serial number of the drive. The serial number itself is embedded in the electronics of the drive and cannot be altered or erased. As the license file contains a number that does not change and is not tied to other hardware in the computer, a new license is not needed upon the replacement of the hardware, such as the graphics or Ethernet cards. If, however, the drive itself is reformatted or repartitioned, the license file is still lost and must be regenerated or recopied. A replacement of the hard drive, and its serial number, will also require a replacement of the license file.

Another common technique is to duplicate the license information and write copies of it into several locations on the drive. This solution solves the problem of having to replace the license if the operating system is reinstalled or replaced, however, it does not prevent the license information from being destroyed if the drive is reformatted or repartitioned.

Traditional methods of license protection for computer programs have focused on disk memory devices. Disk memory devices contain highly polished aluminum or glass plates that are magnetically partitioned into a series of concentric circles or tracks. Disk devices contain a motor for spinning the plates as they are written. The first track of a disk, typically denoted track zero, is reserved for the master boot record and partition table data. The remainder of the tracks are used to store operating system level data.

Portable memory storage devices such as random access memory (“RAM”) memory sticks, memory cards, drives (e.g. USB drives), especially flash memory, are becoming widespread in today's computing environment. It is becoming increasingly necessary to supply, transfer, and carry data and software on such devices. With the additional roles these portable devices play, it is paramount to protect the data and software stored on the devices from illegal copying, access, and alteration.

Flash memory devices, contrary to disk devices, do not contain any moving parts. Flash memory is essentially a rewritable memory chip that can maintain its content without the need of a power supply. Such devices are referred to as non-volatile memory devices. Non-volatile memory devices require electricity to read or write data from its cells, however the cells retain all data in the absence of electrical current. All flash memory devices, similarly to hard disks, have a restricted storage area used to store a master boot record, boot sector, and file allocation tables.

Non-volatile memory is noiseless and is faster, smaller, and lighter that disk devices. Information is stored in an array of floating gate transistors. Non-volatile memory devices, such as SmartMedia, CompactFlash and Sony's Memory Stick are portable memory devices that are used to store and transport data for electronics ranging from home computers, to cameras, to video game consoles.

Present implementations of devices using flash, or other nonvolatile, RAM memory do not have any mechanism to protect the data on the device from being accessed, including both reading and writing, or copied. This presents difficulty in maintaining the integrity and originality of data. The portable nature of the devices leads to unauthorized and illegal reproduction of data and propagates the distribution of protected material. With no way to ensure the security and originality of data stored on these devices, owners and users of sensitive information must use more expensive and archaic means of protecting their data.

Nor do present implementations contain any way to distinguish original memory devices from potentially illegal or unauthorized copies. Replicating the data from one device to another can easily be accomplished, fooling many copy protection systems into recognizing the data as the original version and not an unauthorized copy.

Devices which act as Authentication Keys are also becoming more and more prevalent. Such electronic devices contain some form of a key that authorizes the carrier of the device to access data stored on a computer or other storage device when plugged into the computer. These devices are expensive and require a factory to seal the device prior to shipment, preventing any customization or adaptation of its contents or sector structure after it is manufactured.

Owners and users of sensitive and protectable data are unable to take advantage of the prevalence and cost-effectiveness of portable memory storage devices and all of its applications due to the lack of protection and verification of data contained on such devices.

### SUMMARY OF INVENTION

The present invention provides for memory copy protection by structuring the sector arrangement of memory devices in such a way as to allow access to the data stored in the sectors of the device without compromising the protection of the data. The present invention describes methods of protecting data stored in memory from access and copying, and methods that will enable software to distinguish between original data and illegal or unauthorized copies of the memory. A method and device for securely authorizing the use of a computer program is also provided.

An embodiment of the present invention virtually reduces the size of a memory device, leaving an area of the memory device undetected, unaltered and unused by the operating system or any operating system level software. The inventive embodiment overwrites the size of the device stored in the boot sector of the device, replacing the size with a smaller number. The inventive method then, upon request, resets the size of the device to its original number and is able to write data to those additional memory cells. After the newly written data is stored, the size of the memory device in the boot sector is returned to the smaller number, preventing access from other programs.

Another embodiment of the present invention utilizes a memory device with one or more defective memory cells at known locations. The memory device is identified by the sequence or arrangement of the defective memory cells. A program then attempts to write data to the defective cells and surrounding cells and the reads the results. If the results match the expected output the program is authorized, if the arrangement of defective cells is not matched, the memory device is an unauthorized device containing copied data from the original.

Another embodiment of the present invention utilizes memory devices of non-traditional sizes. A program attempts to write and read from the last memory cell of the device and determines the true amount of memory on the device. Doing so allows the program to determine if the memory device, with the non-traditional size, is the original memory device or if it is an unauthorized device with copied data from the original.

### BRIEF DESCRIPTION OF DRAWINGS

The foregoing and other features and advantages of the present invention will be more fully understood from the following detailed description of illustrative embodiments, taken in conjunction with the accompanying drawings in which:

FIG. 1 provides details of a license table in accordance with an embodiment of the present invention;

FIG. 2A-2C provides a map of a RAM memory device in accordance with an embodiment of the present invention;

FIG. 3 is a flow chart detailing a method of protecting a computer program in accordance with an embodiment of the present invention;

FIG. 4 is a flow chart detailing a method of protecting a computer program in accordance with an embodiment of the present invention; and

FIG. 5 is a flow chart detailing a method of protecting a computer program in accordance with an embodiment of the present invention.

### DETAILED DESCRIPTION

Detailed embodiments of the present invention are disclosed herein, however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the present invention in virtually any appropriately detailed embodiment.

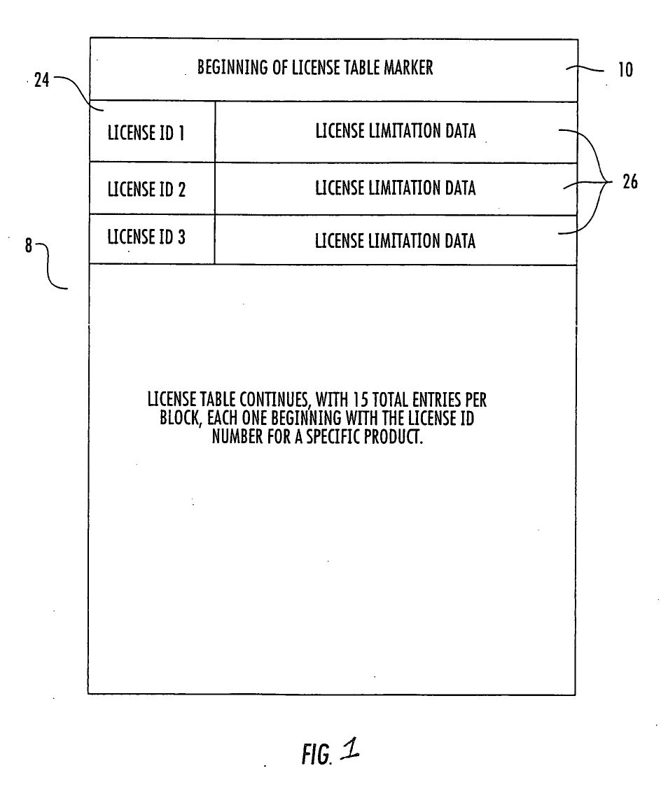

Turning now to FIG. 1, a representation of a license table in accordance with one embodiment of the present invention is shown. The license table is an organized listing of unique identifying information that a protected program can access to determine if the computer, or user, is authorized to access protected the program or data on the computer. The first block of the license table is a license table marker 10 signifying the beginning of the license table 8. The license table 8 is capable of managing multiple license identifications, or License IDs, 24 as well as specific limitation data 26 for each license. This unique identifier information includes the manufacturer identification and the product identifier, as well as the limitation data 26 used to restrict the license. For example, license limitation information may restrict the number of days of usage or evaluation uses, as well as the number of authorized uses or users. The License IDs 24 are generated using a combination of unique customer and product identifiers. Each manufacturer is given a unique identifying number, called a Customer ID and each product is given a unique identifying number, called a Product ID. The license table is capable of growing to accommodate several different licenses.

The License Table Marker 10 is a unique pattern of numbers which is extremely unlikely to be generated accidentally by any other program on a system. The License Table Marker 10, in this embodiment, for example, may be a series of three numbers: 999999999, followed by 4444, followed by 777777777. The first time a License ID 24 is requested, the system generates and stores a random number based on the day, and time. The random number is then combined with the unique Product ID and any license limitations that may be implemented to form the License ID 24 and stored in the License Table 8. Advantageously nothing in the License ID 24 is related to any of the hardware contained in the system upon which the license is installed. Unlike previous methods where license identifiers, also termed Site Codes, were calculated from information gathered about the computer, e.g., hard drive serial numbers, the LAN Ethernet address, CPU, BIOS dates and release numbers, or etc., the License IDs 24 are not encoded into the hardware.

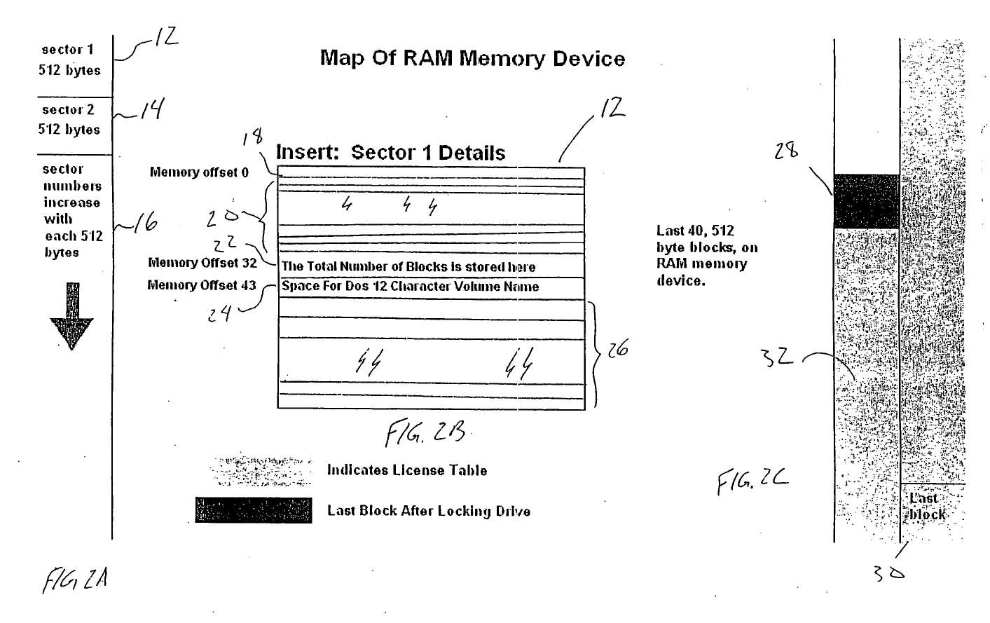

Turning now to FIGS. 2A-C, a map of a RAM memory device is shown. FIG. 2A is a map of a memory cell structure in which each sector comprises 512 bytes. The number of sectors on a memory device is equal to the amount of storage divided by 512. For example, for a 512 megabyte memory device, the typical number of sectors would be 524,288.

Memory devices typically do not contain precisely the amount of information storage listed on a label. Additionally, they do not contain an amount of storage equivalent to the nearest value of 2 raised to a power, e.g., 512, 1024, 2048, 524,288 or 268,435,456. Several brands of 512 megabyte memory devices will all contain different amounts of storage space. Differences of up to 7 megabytes can be found in the amount of storage available on different 256 megabyte memory devices among various brands on the market.

In a memory device used by a Windows operating system, a boot sector, sector one 12 in this embodiment, contains several valuable pieces of information concerning the details of the memory device. This embodiment of the present invention, as shown in FIG. 2B, utilizes two of these pieces of sector one 12. Offset thirty-two 22 contains a four byte value that contains the total number of sectors on the memory device. The four byte value is typically in the same format that Microsoft's C++ uses to store a long integer. Offset forty-three 24 contains twelve unused bytes which were originally reserved for the volume name of the memory device, when file names longer than twelve characters were not allowed. In current devices, volume names may contain more than twelve characters and this memory offset forty-three 24 is no longer used. Sector one 12 contains several other offsets 20, 26 that store other details regarding the memory device.

The operating system, when writing data to a memory device, looks to the boot sector and memory offset thirty-two 22 in order to determine how much memory is on the device. After reading the number of blocks on the device from memory offset thirty-two, the operating system knows it must store any data in blocks numbers below the maximum number. For example, if the number stored in memory offset thirty-two 22 was 5000, i.e. there are 5000 blocks of memory on the device, the operating system must store the data in blocks 2-5000, as sector one 12 is reserved for memory device details.

An embodiment of the present invention virtually alters the size of the memory device by overwriting the value stored in memory offset thirty-two 22 with a smaller number. After doing so, the operating system is then “fooled” into thinking the size of the memory device is limited to the new, smaller value stored in memory offset thirty two 22. As shown in FIG. 2C, this leaves a unused portion of the memory device empty and unrecognized by operating system level programs. The last memory block 28, corresponding to the new value stored in memory offset thirty-two 22 is the end of the device as recognized by the operating system. The operating system cannot read any data stored on the memory device after this block 28 listed in memory offset thirty-two 22.

Knowing the number of existing blocks was artificially reduced, allows the running program to “reset” the value of memory offset thirty-two 22 back to its original value, opening up the remaining blocks of the memory device for sensitive data. For example, in an embodiment in which the number of blocks is 5000, the value in memory offset thirty-two 22 is changed from 5000 to 4000. When the operating system attempts to write data to the memory device, it is limited to blocks 2-4000. The authorizing program, knowing the value of memory offset thirty-two 22 has been reduced, “resets” the value of memory offset thirty-two back to the last real block 30, in this embodiment block 5000. The program can then write sensitive data such as a license table 32 or other authentication means, to memory blocks 4001-5000. After the data is written or read by the program, the value of memory offset thirty-two 22 is returned to 4000. This ensures that operating system level operations cannot alter, copy, or destroy the data stored in the protected area of the memory device.

Memory offset forty-three 24 is used as a marker to signify to the authorizing program whether the memory device is locked or unlocked. In a locked state, the value of memory offset thirty-two 22 is the artificially reduced number and the only access allowed to the device, in this example, is to the blocks from 2-4000. In an unlocked state, the value of memory offset thirty-two 22 is the original and real last block of the memory device, allowing access to the entire range of memory blocks. In the unlocked state, the program may read or write data to the license table 32. Memory offset forty-three 24 can contain a string of characters that signify to the program the current status of the device. As one example, the strings “UNLOCKED” and “LOCKED”, or “USB_DONGLE” and “USB DONGLE” (no underscore), can be used. Any combination of strings may be used so long as there is a difference in the signifying keys.

While the above embodiment utilizes a license table used to provide authentication data to access a program, one skilled in the art should recognize any sensitive data may be stored in such a manner in order to protect it from copying, alteration, or destruction. For example, an authorization key apparatus may be implemented in which a user inserts a portable memory device into a computer to gain access to a program or data. The program then looks to the protected data on the memory device to determine whether the carrier of the device is an authorized user. If the protected data contains an authorization key or code, the program grants access to the user.

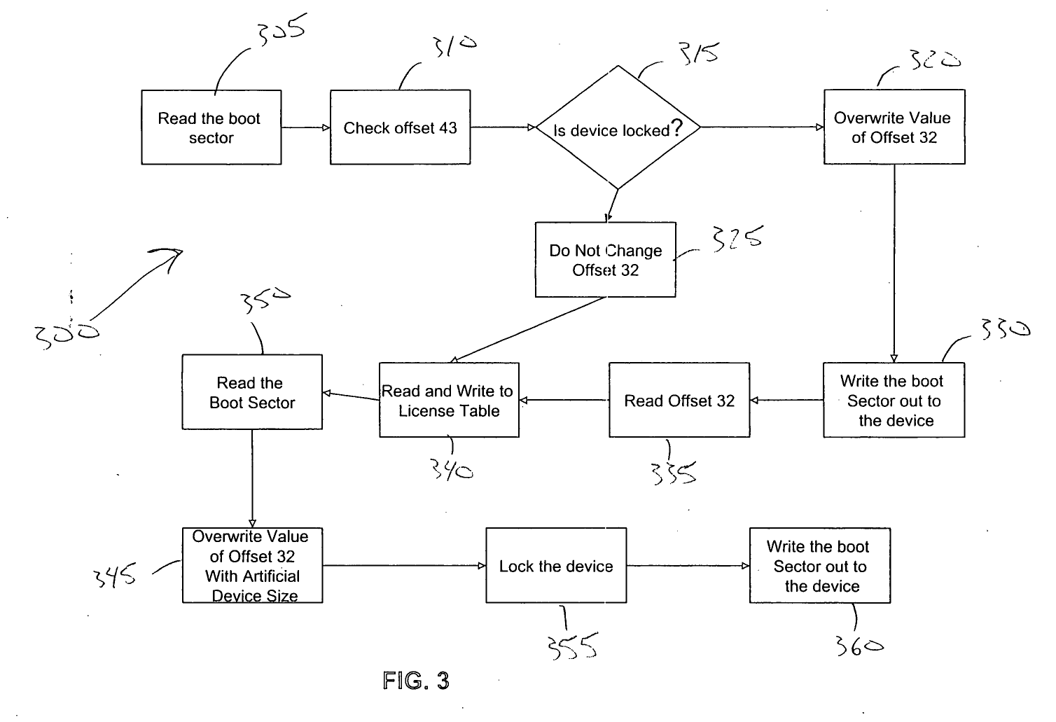

Turning now to FIG. 3, a method 300 of securely reading and writing a license table to a memory device is shown. The authorizing program first reads in the boot sector 305. The program then checks offset forty-three 310 of sector one, the boot sector. The program reads in the character string stored in memory offset forty-three to determine if the device is in a locked or unlocked state 315. If the character string stored in memory offset forty-three signifies that the memory device is unlocked 315, the value stored in memory offset thirty-two, the number of total blocks on the memory device, is not changed 325. If memory offset forty-three signifies that the device is locked, the character string in memory offset forty three is changed to an unlocked state. The value stored in memory offset thirty-two is then overwritten 320 and replaced with a smaller number. The boot sector is then written out to the device 330.

The program then reads in memory offset thirty-two 335 in order to determine the size of the memory device. The program looks to the ultimate memory blocks on the device for a license table. The license table can then be read and written to 340 by the program in order to authorize or validate any data contained in the table. When the authentication or writing process is complete, the program once again reads in the boot sector of the memory device and replaces the number of blocks stored in offset thirty-two with a smaller number. The smaller number stored may be the original size of the device minus the size of the license table or other sensitive data. This minimizes the unused and locked memory blocks while maximizing the amount of blocks available for the operating system programs.

After rewriting offset thirty-two with the artificial size of the drive 345, memory offset forty three is then written to signify a locked state 355 and the boot sector is written out to the memory device. When the operating system reads in the boot sector, it will be “fooled” into thinking the size of the device is only as large as the number stored in memory offset thirty-two. It cannot access any of the data stored in higher memory blocks, thus making that data immune from copying, alteration and destruction by any operating system level programs. Additionally programs that copy data from memory devices sector by sector will read and write only the number of sectors stored in memory offset thirty two. The data is not included in the copy procedure because, in this embodiment, the protected data cannot be “seen” by the copying program.

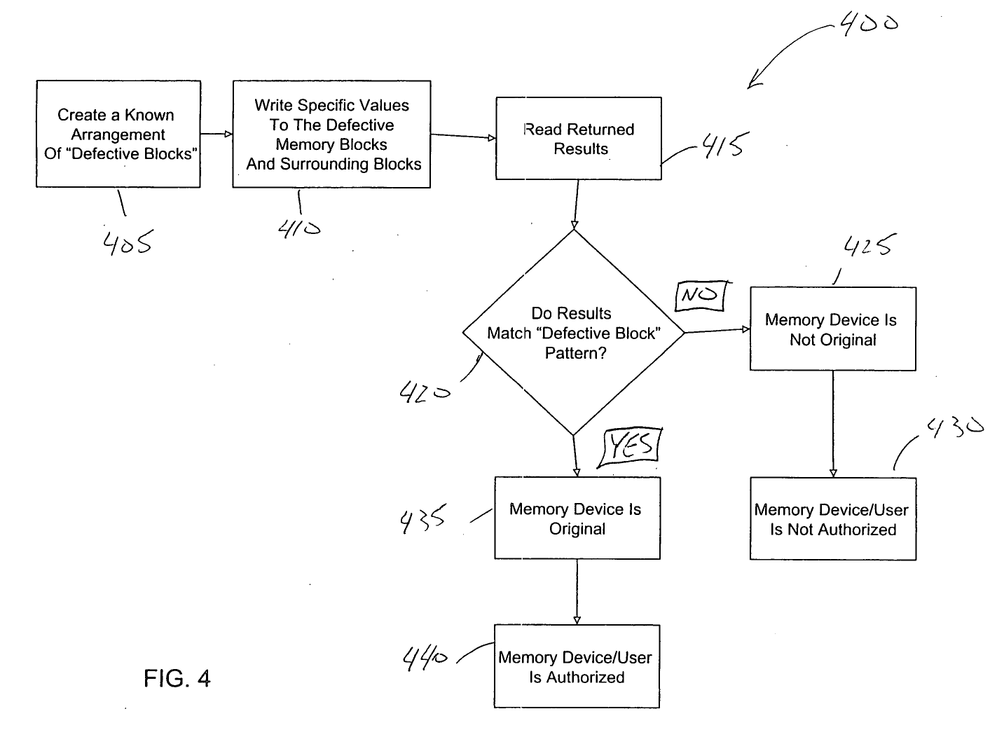

Turning now to FIG. 4 a method 400 of detecting the originality of data stored on a memory device is shown. Previous portable memory storage devices have no way of reporting whether the data stored thereon is truly an original copy or whether the original data was illegally or impermissibly copied to a similar memory device. The method 400 of an embodiment of the present invention verifies that the memory device on which a license table or other sensitive data is stored is an original version and not an unauthorized copy. The program begins by creating an arrangement of defective memory blocks on the memory device 405. This is accomplished by altering or purposefully corrupting the memory cells in known locations using known methods used by filing systems used by the memory device. The arrangement of artificially defective cells is known only to authorized programs.

The authorizing program then attempts to write data to the memory device in the artificially defective memory blocks and surrounding blocks 410. The results of the writing process are returned to and read by the program 415. If the results, i.e. the error messages, do not match the defective program pattern, known to the program 420, the program knows the memory device on which the data was originally stored is not the memory device being read 425. If the memory device is not an original, the user or memory device is not authorized to use the protected program or data 430. If the resultant errors match the expected defective block pattern, the memory device and the data stored thereon is original 435 and the user or memory device is authorized to read or write data 440.

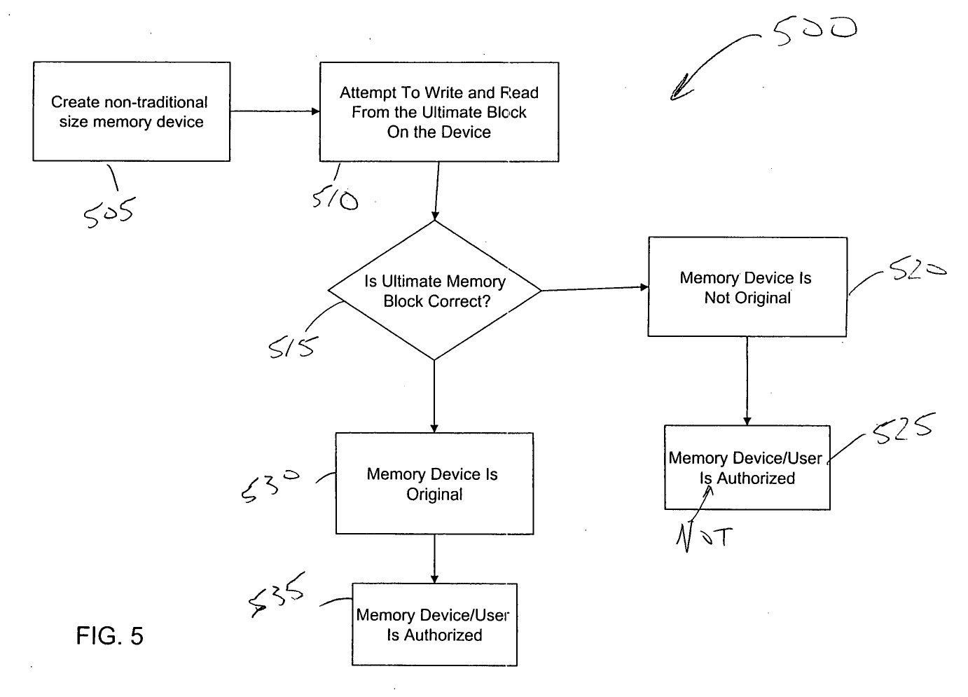

Turning now to FIG. 5, another embodiment of the present invention is shown in which a method 500 of authenticating an original memory device and its data is shown. The embodiment utilizes a memory structure of non-traditional sizes. Traditional sizes or memory devices are those typically found in the market such as 64 megabytes (“MB”) 128 MB, 512 MB, 1 gigabyte (“GB”), etc. Using methods described above, the program creates a non-traditional memory size structure 505 known only to the program. The program then attempts to write and read from the ultimate, or last block on the device 510. In one embodiment, this is the block corresponding to the block number listed in memory offset thirty two of the boot sector. The authorizing program, knowing what the correct value of the ultimate memory block should be determines if the returned memory block is correct 515. If a non-expected memory block is returned the memory device is not original 520 and the original data has been copied from one device to another. The memory device and user are not authorized to access the program or data 525. If the returned memory block is the expected number, the memory device is the original 530 and the memory device and user are authorized 535 to use the program or data. The present embodiment provides a method of ensuring the originality of data stored on a memory device. Copies of data onto traditionally sized memory devices will return an incorrect ultimate memory block and the program will not authorize the user.

Although the embodiments illustrated herein discuss a memory device generally, one skilled in the art should recognize that any device used to store electronic data, e.g. USB drives, hard disk drives, RAM memory sticks, flash memory, and other non-volatile RAM devices may be utilized without deviating from the scope of the invention.

Additionally, while the above illustrated embodiments reference a Microsoft Windows operating system, one skilled in the are should recognize that the present invention is not limited to a specific operating system. Linux, Macintosh, and other operating systems may be used without deviating from the scope of the present invention.

While the above listed embodiments refer to a memory device having 5000 available memory blocks of 512 bytes each, one skilled in the art should recognize that any size of the memory device and sector structure may be implemented without deviating from the scope of the invention.

Although the embodiments illustrated herein disclose memory offset thirty-two as the location of the size of the memory device, one skilled in the art should appreciate that any memory block designated by an operating system to hold such data may be utilized in accordance with the scope of the invention. Additionally, while offset forty-three is disclosed as the memory block used to store the locked/unlocked state of the device, one skilled in the art should recognize any memory block may be utilized to store such information without deviating from the scope of the invention.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A method of storing data comprising:
locating a first data block on a electronic medium, the data block containing a first number corresponding to a maximum number of memory blocks on the electronic medium;
replacing the first number with a second number smaller than the first number; and
writing data to memory blocks located between the fist and second number, the data immune from operations of an operating system and any program dependent thereon.

2. The method of claim 1, further comprising:
reading a status data block on the disk media, the status memory block signifying a first state or second state, the first state signifying the first number is stored in the first data block, the second state signifying the second number is stored in the first data block.

3. The method of claim 2, wherein the status memory block contains a character string.

4. The method of claim 1, wherein the first data block is located on a boot sector of the electronic medium.

5. The method of claim 1, further comprising subtracting a third number from the first number to obtain the second number, the third number representing the size of the data to be written to the disk.

6. The method of claim 1, wherein the second number is a non-traditional memory size.

7. The method of claim 1 further comprising:
marking a unique pattern of memory blocks on the electronic medium as defective blocks;
writing data to the unique pattern of memory blocks and adjacent memory blocks; and
analyzing results of writing data to determine the originality of the electronic medium, the originality confirmed if the results of the writing operation match expected results from knowing the unique pattern of defective memory blocks.

8. A device for protecting data from unauthorized access and copying comprising:
an electronic medium comprising a plurality of memory blocks; and
a first memory block comprising a first number, the first number corresponding to a number of usable memory blocks on the electronic medium, the first number being smaller than a maximum number of memory blocks on the electronic medium, the memory blocks located between the first number and the maximum number being inaccessible to an operating system and any program dependant thereon, and thereby immune from operations being performed on the memory blocks located between the first number and the maximum number.

9. The device of claim 8, further comprising a second memory block comprising a status marker, the status marker signifying whether the first memory block comprises the first number or the maximum number of memory blocks.

10. The device of claim 9 wherein, the status marker is a character string.

11. The device of claim 9 wherein the first memory block is located on a boot sector or the electronic medium.

12. The device of claim 9 wherein a difference between the first number and the maximum number corresponds to a size of data to be written to the electronic medium.

13. The device of claim 9 wherein the first number is a non-traditional memory size.

14. The device of claim 9, wherein the electronic medium is a USB memory card.

15. The device of claim 9 further comprising a plurality of defective memory blocks, the plurality of defective memory blocks creating a unique identifying pattern.

16. A method of protecting data from unauthorized access and copying:
reading a first memory block located on a boot sector of an electronic medium; the first memory block comprising a status marker, the status marking signifying a first or second state of the electronic medium;
reading a second memory block located on the boot sector; the second memory block comprising a first number in the first state, the first number corresponding to the maximum number of memory blocks on the electronic medium; the second memory block comprising a second number in the second state, the second number corresponding to a usable number of memory blocks on the electronic medium, the second number smaller than the first number;
changing the second number in the second memory block to the first number;
writing data to memory blocks located between the first and second number on the electronic medium;
changing the first number of the second memory block to the second number, such that a computer reading the electronic medium is able to access only the data up to the second number, the data written being inaccessible to any operating system operation and immune from the operating system and any program dependant thereon; and
changing the state of the status marker.

17. The method of claim 16 wherein the first number is a non-traditional memory size.

18. The method of claim 16, wherein the status memory block contains a character string.

19. The method of claim 17 wherein the electronic medium is a USB memory drive.

20. The method of claim 16 wherein the electronic medium is a flash drive.
